(19) United States
(12) Patent Application Publication
(10) Pub. No.: US 2017/0192467 A1
(43) Pub. Date: Jul. 6, 2017

(54) HINGE ASSEMBLIES

(71) Applicant: Lenovo (Singapore) Pte. Ltd., Singapore (SG)

(72) Inventors: Joseph Anthony Holung, Wake Forest, NC (US); Tin-Lup Wong, Chapel Hill, NC (US); Bouziane Yebka, Apex, NC (US); Philip John Jakes, Durham, NC (US)

(21) Appl. No.: 14/986,671

(22) Filed: Jan. 2, 2016

(51) Int. Cl. G06F 1/16; E05D 3/18; E05D 11/00; E05D 3/12; E05D 11/10

(52) U.S. Cl. CPC G06F 1/1681; E05D 3/122; E05D 11/10; E05D 11/0054; E05D 3/18; G06F 1/1616; G06F 1/1635; G06F 1/1662; E05Y 2900/606

(57) ABSTRACT

An apparatus can include a processor; memory accessible by the processor; a first housing that includes a front side and a back side; a second housing that includes a front side and a back side; and a hinge assembly operatively coupled to the second housing where the hinge assembly includes a set of axles, a set of gears and a latch pivotable via meshed rotation of the gears about an axis defined by one of the axles where, in a latched state, the latch operatively couples the first housing to the hinge assembly.

### TECHNICAL FIELD

Subject matter disclosed herein generally relates to technology for hinges, for example, hinge assemblies for computing devices.

### BACKGROUND

Various types of computing devices, display devices, computing and display devices, etc. exist where, for example, one device may cooperate with another device or component of an assembly or system. As an example, consider a display in a display housing that cooperates with a keyboard in a keyboard housing, which may, for example, allow for input of information via the display in addition to, or as an alternative to, input of information via the keyboard. In such an example, the keyboard housing and the display housing may connect via a hinge, for example, that allows for pivoting of the housings to achieve a back-to-back orientation of the keyboard housing and the display housing. In such an orientation, the display may be used on one side as a tablet (e.g., consider a scenario where the display is a touchscreen display) while the keyboard faces outwardly from the opposing side. Various technologies and techniques described herein pertain to devices, components, assemblies, etc. that include a keyboard in a keyboard housing.

### SUMMARY

An apparatus can include a processor; memory accessible by the processor; a first housing that includes a front side and a back side; a second housing that includes a front side and a back side; and a hinge assembly operatively coupled to the second housing where the hinge assembly includes a set of axles, a set of gears and a latch pivotable via meshed rotation of the gears about an axis defined by one of the axles where, in a latched state, the latch operatively couples the first housing to the hinge assembly. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a diagram of examples of systems;

FIG. 2 is a diagram of an example of a system and an example of a method;

FIG. 3 is a diagram of an example of the system of FIG. 2 with an example of a hinge assembly;

FIG. 4 is a diagram of an example of the system of FIG. 2 with an example of a housing;

FIG. 5 is a diagram of an example of a hinge assembly;

FIG. 6 is a diagram of an example of an assembly;

FIG. 7 is a diagram of an example of an assembly;

FIG. 8 is a diagram of an example of a latch;

FIG. 9 is a diagram of an example of a mechanism of the latch of FIG. 8;

FIG. 10 is a diagram of an example of a system and examples of components;

FIG. 11 is a diagram of the system of FIG. 10 and an example of a graphical user interface;

FIG. 12 is a diagram of an example of an assembly;

FIG. 13 is a diagram of a portion of the assembly of FIG. 12;

FIG. 14 is a diagram of a portion of the assembly of FIG. 12;

FIG. 15 is a diagram of a portion of the assembly of FIG. 12;

FIG. 16 is a diagram of a portion of an example of an assembly;

FIG. 17 is a diagram of an example of an assembly;

FIG. 18 is a diagram of portions of examples of hinge assemblies; and

FIG. 19 is a diagram of an example of a system that includes one or more processors.

### DETAILED DESCRIPTION

The following description includes the best mode presently contemplated for practicing the described implementations. This description is not to be taken in a limiting sense, but rather is made merely for the purpose of describing general principles of various implementations. The scope of invention should be ascertained with reference to issued claims.

As an example, a system may include a display in a display housing that cooperates with a keyboard in a keyboard housing, which may, for example, allow for input of information via the display in addition to, or as an alternative to, input of information via the keyboard. In such an example, the keyboard housing and the display housing may connect via a hinge assembly (e.g., or hinge assemblies) that, for example, allows for pivoting of the housings, for example, to achieve a folded orientation of the keyboard housing and the display housing. As an example, where a display faces outwardly in a folded orientation, the display of the system may be used as a tablet (e.g., consider a scenario where the display is a touchscreen display).

As an example, a system can include multiple housings where at least one of the housings is a display housing. As an example, a system can include two display housings coupled via one or more hinge assemblies where the display housings may be pivotable to a planar orientation and pivotable to a folded orientation, which may be one of a back-to-back, a front-to-back or a front-to-front orientation. As an example, a system can include a plurality of housings where one or more of the housings may be display housings and, for example, where one or more of the housings may be input component housings such as, for example, keyboard housings, touchscreen display housings, etc. In such an example, hinge assemblies can be included, which may optionally allow for decoupling and recoupling of one or more of the housings.

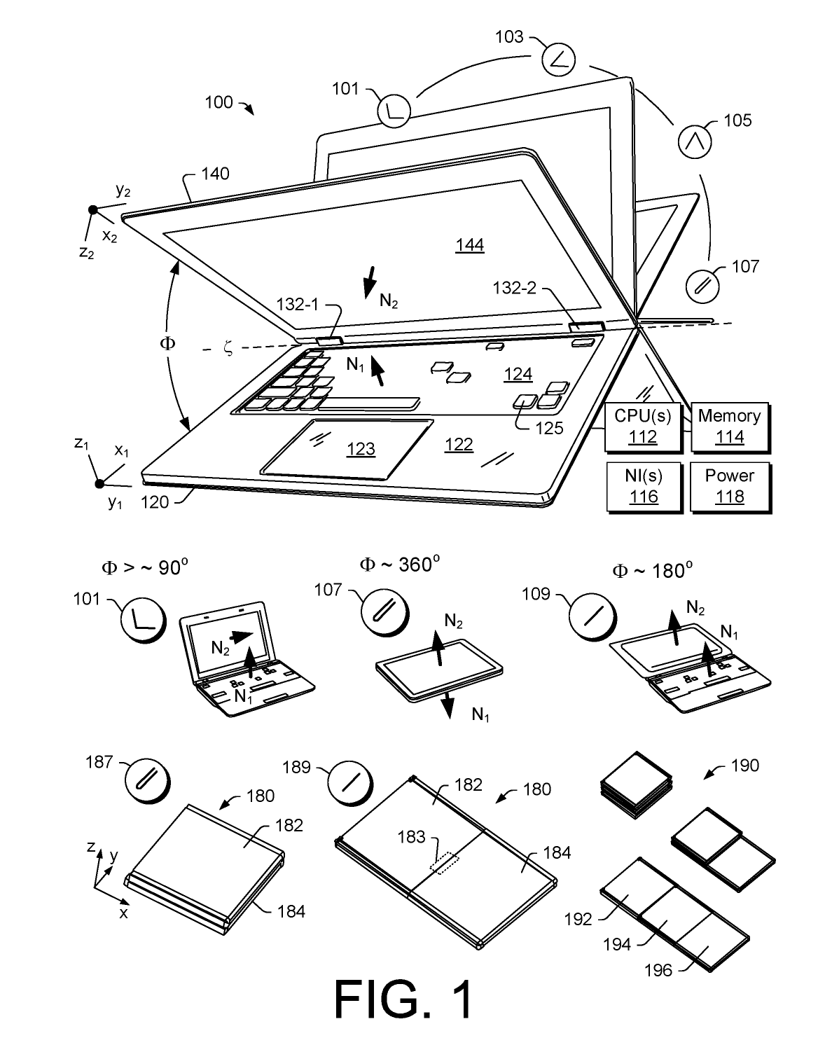

FIG. 1 shows an example of a system 100 that includes a keyboard housing 120 and a display housing 140 that are pivotable with respect to each other via movement about one or more hinges 132-1 and 132-2 (e.g., hinge assemblies). FIG. 1 also shows an example of a system 180 that includes a first housing 182 and a second housing 184 that are pivotable with respect to each other via movement about one or more hinges 183 and an example of a system 190 that includes a first housing 192, a second housing 194 and a third housing 196 that may be pivotable with respect to each other via movement about hinges.

As an example, the system 100, the system 180 and/or the system 190 may include one or more processors 112, memory 114 (e.g., one or more memory devices), one or more network interfaces 116, and one or more power cells 118. Such components may be, for example, housed with the keyboard housing 120, the display housing 140, the keyboard housing 120 and the display housing 140, the housing 182, the housing 184, the housing 182 and the housing 184, one or more of the housings 192, 194 and 196, etc.

As shown in the example of FIG. 1, the keyboard housing 120 includes a keyboard 124 with keys 125 and the display housing 140 includes a display 144. In such an example, the keyboard 124 is defined in a first Cartesian coordinate system as having a width along an x-axis (x₁), a length along a y-axis (y₁) and a height along a z-axis (z₁) that extends in a direction outwardly away from touch surfaces of keys 125 of the keyboard 124 and the display 144 is defined in a second Cartesian coordinate system as having a width along an x-axis (x₂), a length along a y-axis (y₂) and a height along a z-axis (z₂) that extends in a direction outwardly away from a viewing surface of the display 144.

As shown in the example of FIG. 1, the one or more hinges 132-1 and 132-2 pivotably connect the keyboard housing 120 and the display housing 140 for orienting the display housing 140 with respect to the keyboard housing 120. For example, orientations may include orientations definable with respect to an axis (e.g., or axes) such as the axis and an angle Φ about that axis.

FIG. 1 shows some examples of orientations 101, 103, 105, 107 and 109. The orientation 101 may be a notebook orientation where the angle Φ is about 90 degrees or more (e.g., or optionally somewhat less than about 90 degrees depending on position of a user, etc.). As shown, for the orientation 101, a user may use a finger or fingers of one or both hands to depress keys 125 of the keyboard 124 (e.g., touch typing), for example, while viewing information being rendered to the display 144 of the display housing 140 (e.g., using the one or more processors 112, the memory 114, etc. that may be included in the keyboard housing 120, the display housing 140 or both). As an example, the keyboard housing 120 may include a frontal surface 122 and may include a touch input surface 123 (e.g., of a touch input device such as a touchpad). As an example, the keyboard 124 may include one or more other input devices (e.g., a control stick, etc.).

As to the orientation 103, it may correspond to a display orientation for viewing the display 144 where the keyboard 124 faces downward and the system 100 is supported by the keyboard housing 120 (e.g., by a rim about the keyboard 124, the frontal surface 122, etc.). As to the orientation 105, it may correspond to a “tent” orientation where the display 144 faces outwardly for viewing on one side of the tent and the keyboard 124 of the keyboard housing 120 faces outwardly on the other side of the tent.

The orientation 107 may be a tablet orientation where the angle Φ is about 360 degrees such that a normal outward vector N₁ of the keyboard 124 of the keyboard housing 120 and a normal outward vector N₂ of the display 144 of the display housing 140 are oriented in oppositely pointing directions, pointing away from each other; whereas, in contrast, for a closed orientation of the system 100 (e.g., where the angle Φ is about 0 degrees), the vectors N₁ and N₂ would be pointing toward each other.

The orientation 109 may be a planar orientation where the angle Φ is about 180 degrees such that a normal outward vector N₁ of the keyboard 124 of the keyboard housing 120 and a normal outward vector N₂ of the display 144 of the display housing 140 are oriented in approximately the same pointing directions.

As shown in FIG. 1, the system 180 can include a folded orientation 187 and a planar orientation 189. As an example, one or both of the housings 182 and 184 may include a display. As shown in FIG. 1, the system 190 can include various orientations, including, for example, a planar orientation of the three housings, a partially folded orientation and a folded orientation. As an example, a three housing system may be configurable in more than one folded orientation with respect to a “middle” housing. For example, the housings 192 and 196 may be folded with respect to the housing 194 with the housing 192 on the top side or bottom side or with the housing 196 on the top side or bottom side.

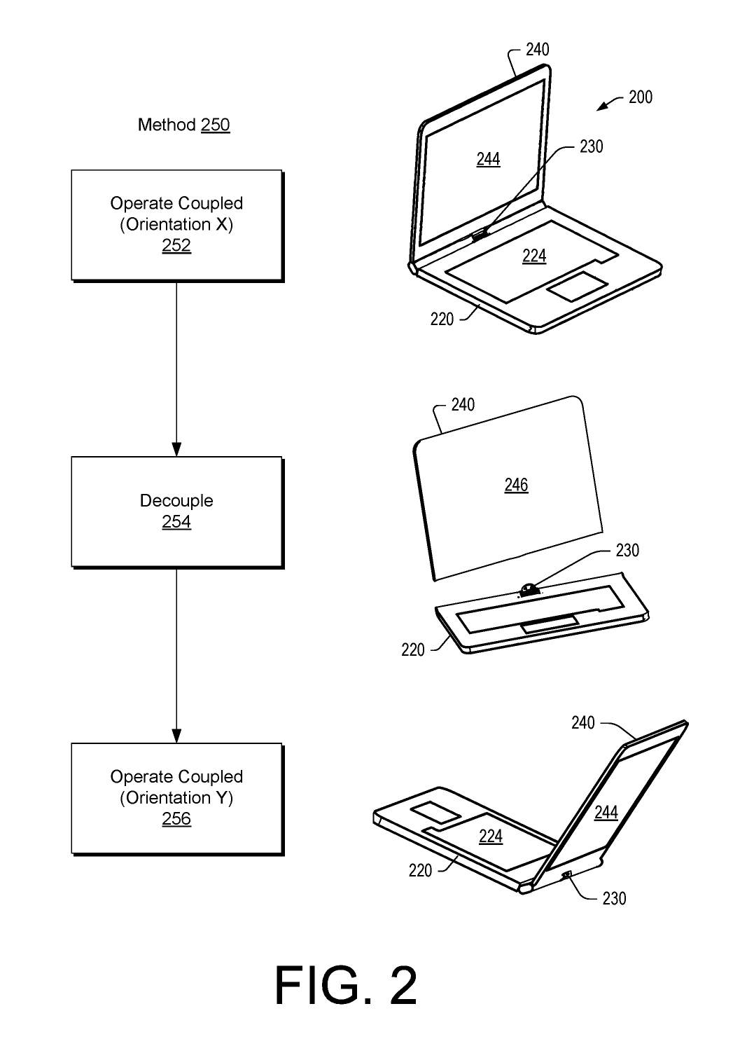

FIG. 2 shows an example of a system 200 and an example of a method 250. As shown, the system 200 includes two housings 220 and 240 operatively coupled via a hinge assembly 230. As shown in the example of FIG. 2, a latch portion of the hinge assembly 230 may be substantially centered along an axial lengthwise dimension such that it can function in a plurality of orientations of a housing or housings.

In the example of FIG. 2, the housing 220 includes a keyboard 224 that defines a keyboard side of the housing 220 and the housing 240 includes a display 244 that defines a display side of the housing 240. The hinge assembly 230 allows for decoupling of the housing 240 (e.g., from a first orientation) and recoupling of the housing 240 such that a back side 246 can face the keyboard side of the housing 220 (e.g., to a second orientation). In such an example, the housing 240 may be rotated in a clamshell manner such that the back side 246 covers the keyboard 224. In such an example, a back side of the housing 220, which may not include a keyboard 224 (e.g., may be a relatively smooth, substantially planar surface, etc.), may form a back side of a tablet orientation of the system 200 where the display 244 may be an outwardly visible display of the tablet orientation. As an example, the display 224 may be a touchscreen display and/or a stylus sensitive display. In the example orientations of FIG. 2 (e.g., top orientation and bottom orientation), the housings 220 and 240 can substantially align at their side edges.

As mentioned, a latch portion of the hinge assembly 230 can be substantially centered along an axial lengthwise dimension, which may correspond to an edge dimension of the housing 220 and an edge dimension of the housing 240. For example, the housing 240 can include a single receptacle that can receive the latch portion of the hinge assembly 230 in multiple orientations of the housing 240 with respect to the housing 220. As an example, the housing 220 can include a single receptacle that can receive another latch portion of the hinge assembly 230. As an example, the hinge assembly 230 may be oriented in various orientations and receive via one latch portion one housing and receive via another latch portion, another housing.

As an example, a hinge assembly may include multiple latch portions. For example, consider a two axle hinge assembly with two latch portions or a three axle hinge assembly with three latch portions where, for example, in the two foregoing examples, at least one housing may be operatively coupled to a latch portion.

As an example, a housing may include a receptacle along one edge and an receptacle along another edge. In such an example, the housing may be oriented such that either receptacle can receive a latch portion of a hinge assembly.

As to the method 250, it includes an operation block 252 for operating a coupled system in a first orientation, a decouple block 254 for decoupling a housing of the system from another housing of the system and an operation block 256 for operating the system in a second orientation that differs from the first orientation. For example, the method 250 may be performed with respect to the system 200 where the system 200 can be operated in two different orientations, which may be a notebook orientation and a tablet orientation.

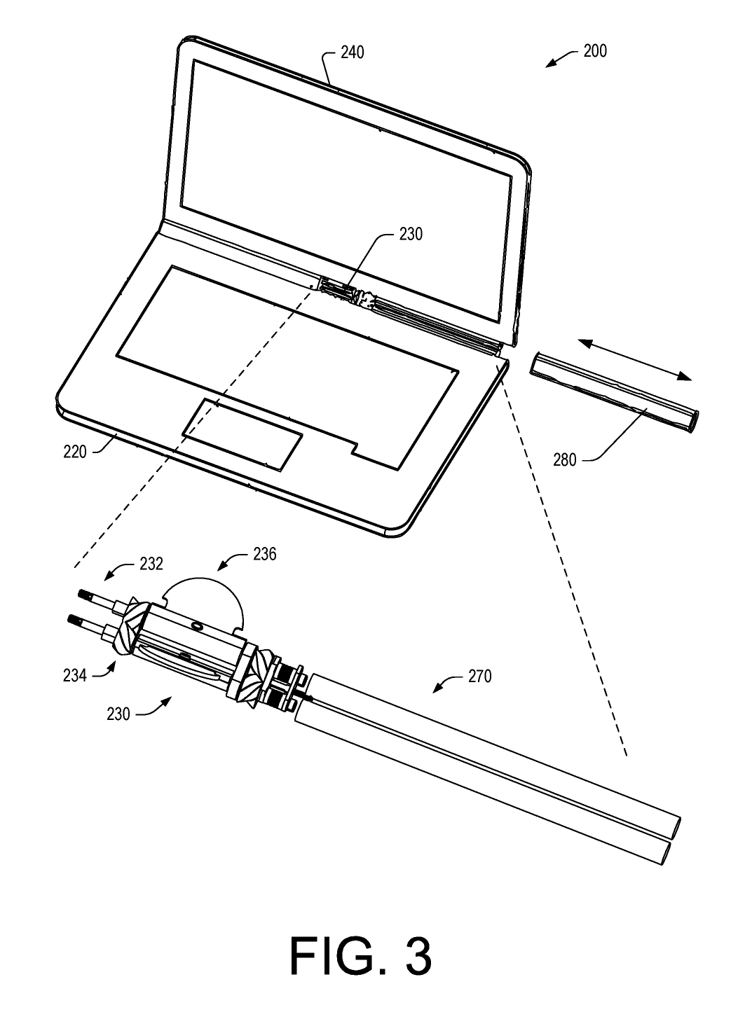

FIG. 3 shows the system 200 with an enlarged view of an example of the hinge assembly 230. As an example, the system 200 may be an apparatus that includes a processor; memory accessible by the processor; the housing 240 as a first housing that includes a front side and a back side; the housing 220 as a second housing that includes a front side and a back side; and the hinge assembly 230 operatively coupled to the second housing 220 where the hinge assembly 230 includes a set of axles 232, a set of gears 234 and a latch 236 pivotable via meshed rotation of the gears 234 about an axis defined by one of the axles 232 where, in a latched state, the latch operatively couples the first housing 240 to the hinge assembly 230.

As an example, the hinge assembly 230 can include one or more components 270, which may be covered at least in part by a cover 280. As an example, the cover 280 may be at least in part translatable to cover the one or more components 270.

In the example of FIG. 3, the one or more components 270 are illustrated as being two components with substantially cylindrical shapes. As an example, a component or components may be of or include a different type of shape. As an example, a component may be characterized by a length and a width where the length may be greater than the width such that the component has an aspect ratio where its length is at least several times greater than its width.

As an example, a component may be a battery cell (e.g., a lithium ion cell, etc.), a stylus, a heat pipe, an antenna, a cooling vent, etc. As an example, a system may allow for interchangeable components. For example, a system may include two slots where the two slots can receive a same type of component or can receive different types of components. As an example, a system can include two slots where one or both slots can receive a battery, where one or both slots can receive a stylus, where one or both slots can receive a heat pipe, where one or both slots can receive an antenna, where one or both slots can receive a cooling vent, etc.

As an example, the cover 280 may cover at least a set of gears. For example, a hinge assembly can include two sets of gears where one set of gears may be covered by one cover and where the other set of gears may be covered by another cover. In such an example, one or both of the covers may be removable. As an example, a system may include one or more slots that extend axially away from one set of gears (e.g., in a first direction) and may include one or more slots that extend axially away from another set of gears (e.g., in a second, opposing direction). As an example, such slots may be empty or occupied by one or more components. As an example, fewer than all slots may be occupied by a component or components.

As an example, a component may be an accessory. As an example, a component may be electrically coupled to circuitry in a housing or housings. As an example, an accessory may be passive. For example, consider a cooling vent that is shaped to direct flow of air into and/or out of one or more housings (e.g., as may be driven by a fan or fans, etc.).

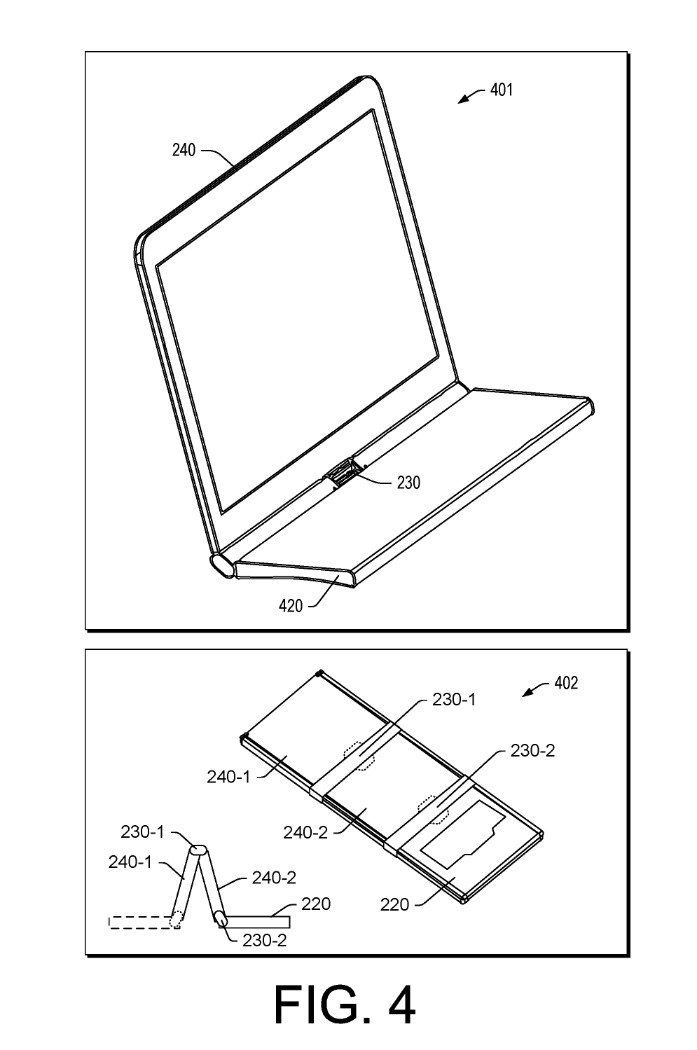

FIG. 4 shows an example of a portion of the system 200 in a configuration 401 where the housing 220 is replaced with a different housing 420, which may be a stand, which may optionally include circuitry and/or one or more other components (e.g., passive and/or active). In such an example, the housing 220 may be decoupled from the hinge assembly 230 and the housing 420 coupled to the hinge assembly 230. As an example, the housing 420 may house one or more electronic components such as, for example, a battery or batteries. As an example, the housing 420 may be shaped to function as a hand grip, which may be suitable for gripping via a user's left hand and/or a user's right hand. As an example, the housing 420 may be a stand that is shaped to rest and/or couple to a dashboard, a table, etc. As an example, the housing 420 may be a dock and may include one or more ports (e.g., power, USB, video and/or audio, network, etc.).

FIG. 4 also shows an example of a configuration 402 where two housings 240-1 and 240-2 are operatively coupled via a hinge assembly 230-1 and where the housing 240-2 is operatively coupled via a hinge assembly 230-2 to the housing 220. In such an example, the housings 240-1 and 240-2 may be oriented such that two people can view displays (see, e.g., tented orientation in the lower left view of FIG. 4). As an example, another housing such as the housing 220 may be operatively coupled to the housing 240-1 such that two people can interact with a system that includes, for example, four housing operatively coupled via three hinge assemblies.

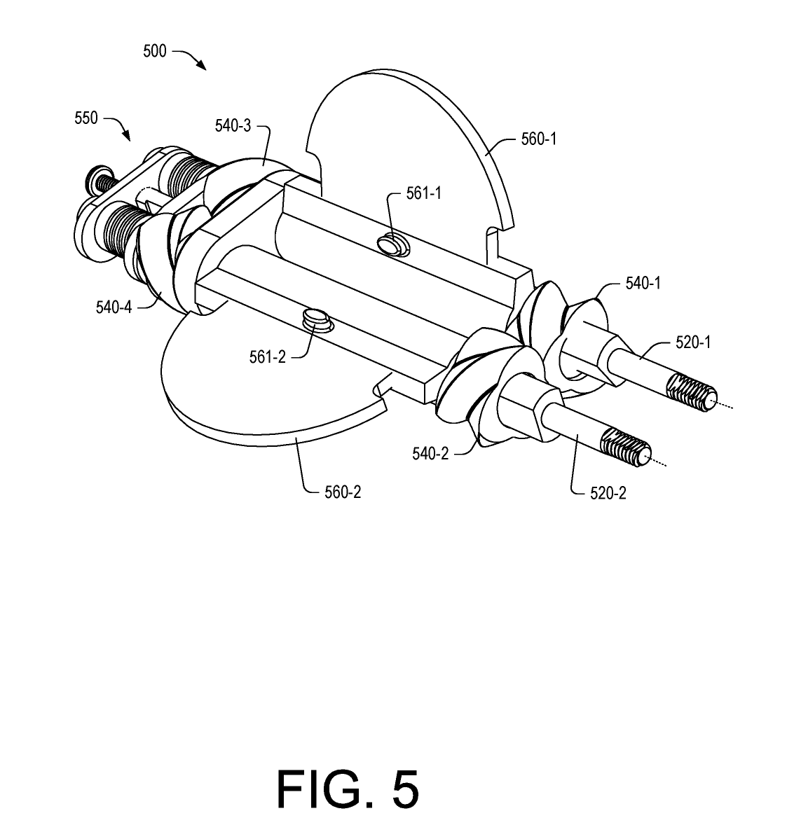

FIG. 5 shows an example of a hinge assembly 500 that includes axles 520-1 and 520-2, gears 540-1, 540-2, 540-3 and 540-4, a mechanism 550, and latches 560-1 and 560-2. As shown in the example of FIG. 5, the latch 560-1 includes a release button 561-1 and the latch 560-2 includes a release button 561-2. The release buttons 561-1 and 561-2 may be actuatable to release a housing from a respective one of the latches 560-1 and 560-2. As an example, each of the axles 520-1 and 520-2 can define a respective axis about while a housing coupled to a respective, corresponding one of the latches 560-1 and 560-2 may pivot. As an example, the release buttons 561-1 and 561-2 can be accessible to a user when a housing is operatively coupled to a respective, corresponding one of the latches 560-1 and 560-2. As an example, the release buttons 561-1 and 561-2 may be oriented such that they can face each other in a first orientation and face away from each other in a second orientation. As an example, a hinge assembly can include release buttons on more than one side. For example, consider a hinge assembly with two release buttons such as the release button 561-1 and another release button being positioned on an opposing side of the latch 560-1.

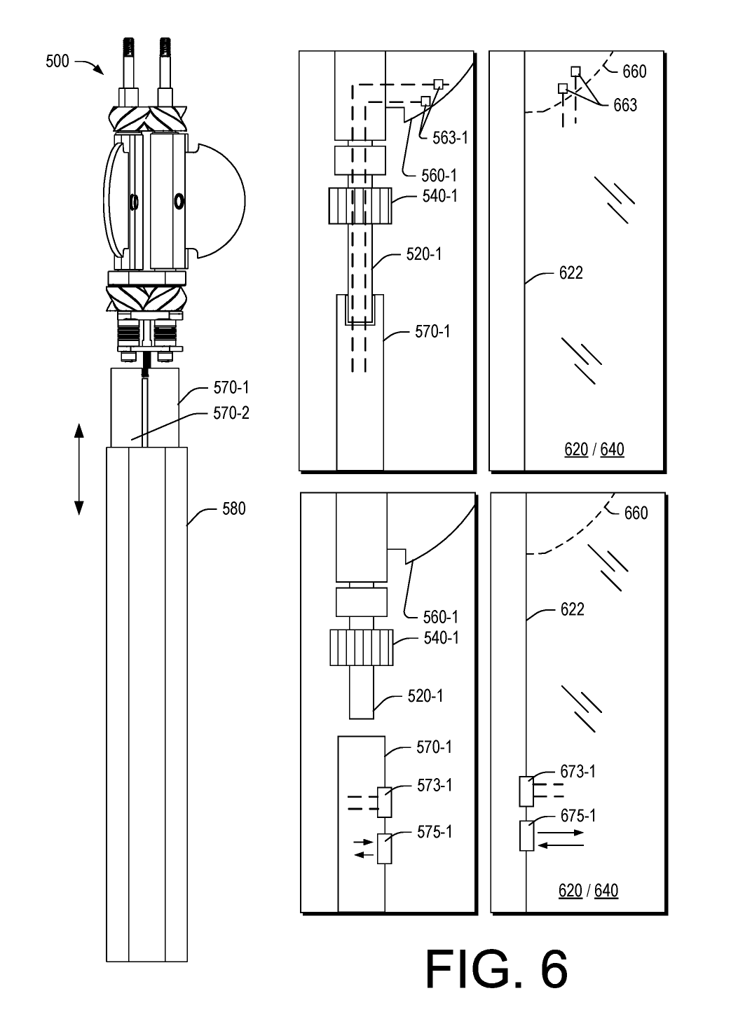

FIG. 6 shows a side view of the hinge assembly 500 and components 570-1 and 570-2, which may be covered by a hinge assembly housing or cover 580. FIG. 6 also shows examples of features that may be included in a hinge assembly, associated components, a housing, etc.

As an example, circuitry may be included to operatively couple one or more components associated with a hinge assembly to one or more components of a housing or housings. For example, wires or other types of conductors may run along or through the axle 520-1 and extend to a portion of the latch 560-1 with one or more contacts 563-1 and a housing 620 (e.g., with a keyboard, etc.) or a housing 640 (e.g., with a display, etc.) can include an edge 622 with a receptacle 660 where one or more contacts 663 may mate with the one or more contacts 563-1. As an example, the contacts 663 may be located symmetrically and/or asymmetrically with respect to a housing. For example, as the housing may be oriented to two or more orientations, pairs of asymmetric contacts may be included and/or symmetric contacts may be included where symmetric contacts can make connections in a plurality of orientations of a housing. As an example, one or more edges of a housing may include a receptacle that can receive a latch of a hinge assembly (see, e.g., the configuration 402 of FIG. 4).

FIG. 6 also shows example features such as connectors 573-1, 575-1, 673-1 and 675-1. Such connectors may be for electrical connections and/or air flow connections. As an example, a component such as the component 570-1 may include an air mover such as a fan where power for the fan (e.g., and optionally control commands, etc.) may be available by coupling of the connectors 573-1 and 673-1 and air may be moved in one or more directions via operation of the fan via coupling of the connectors 575-1 and 675-1. In such an example, the component 570-1 may be a cooling accessory that includes one or more air movers and that can direct air into and/or air out of a housing or housings.

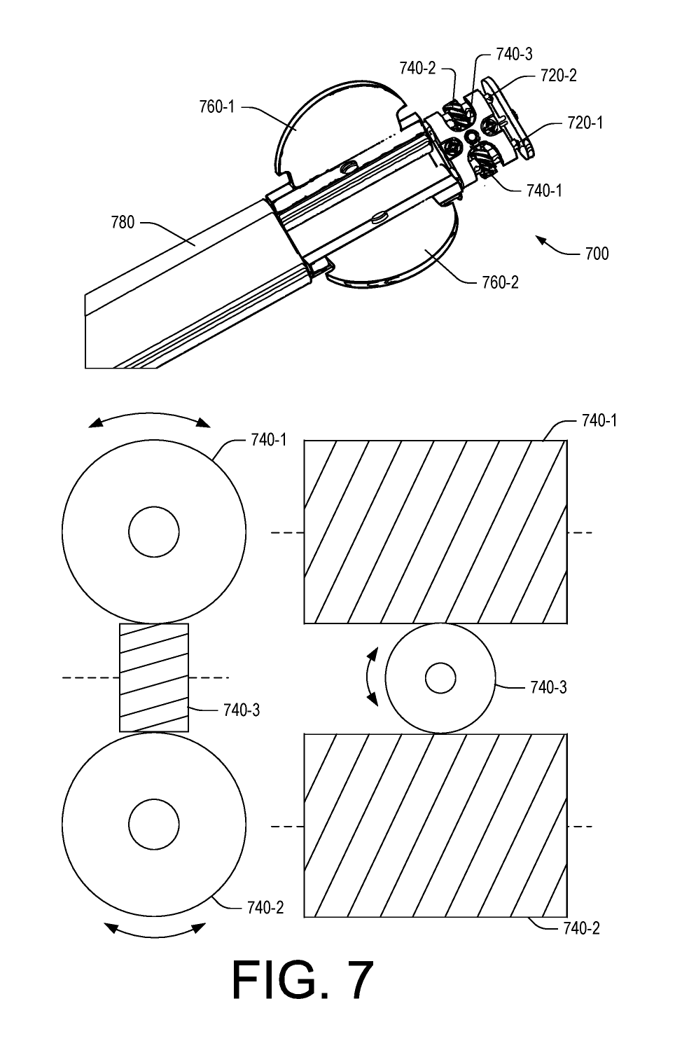

FIG. 7 shows a perspective view of a hinge assembly 700 that includes axles 720-1 and 720-2, gears 740-1, 740-2 and 740-3, latches 760-1 and 760-2 and a cover 780. As shown in the example of FIG. 7, the latch 760-1 includes a release button 761-1 and the latch 760-2 includes a release button 761-2. The release buttons 761-1 and 761-2 may be actuatable to release a housing from a respective one of the latches 760-1 and 760-2.

In the example of FIG. 7, the gears 740-1 and 740-2 are shown as having axes that are substantially parallel and the gear 740-3 has an axis that is oriented orthogonally to the axes of the gears 740-1 and 740-2. In the assembly 700, the gear 740-3 may be a space gear that acts to couple the gears 740-1 and 740-2, for example, to accommodate a difference in space between the axles 720-1 and 720-2 (e.g., for two housings operatively coupled to the latches 760-1 and 760-2).

As an example, an assembly can include an intermediate gear or intermediate gears. For example, the gear 740-3 may be considered to be an intermediate gear. As an example, a hinge assembly may include one or more intermediate gears that may be sized with respect to a pair of gears, for example, to minimize size of the hinge assembly, for example, by offsetting of one or more intermediate gear(s) from a centered position, it is possible to achieve a result that shortens a distance between centers of the two main gears. In such an example, an intermediate gear or intermediate gears allows for assemblies of different thicknesses of housings to possibly implement a standard pair of main gears (e.g., where adjustments occur via sizing, positioning, etc. of one or more intermediate gears). As an example, a three gear set may include an intermediate gear offset from centers of the other two gears.

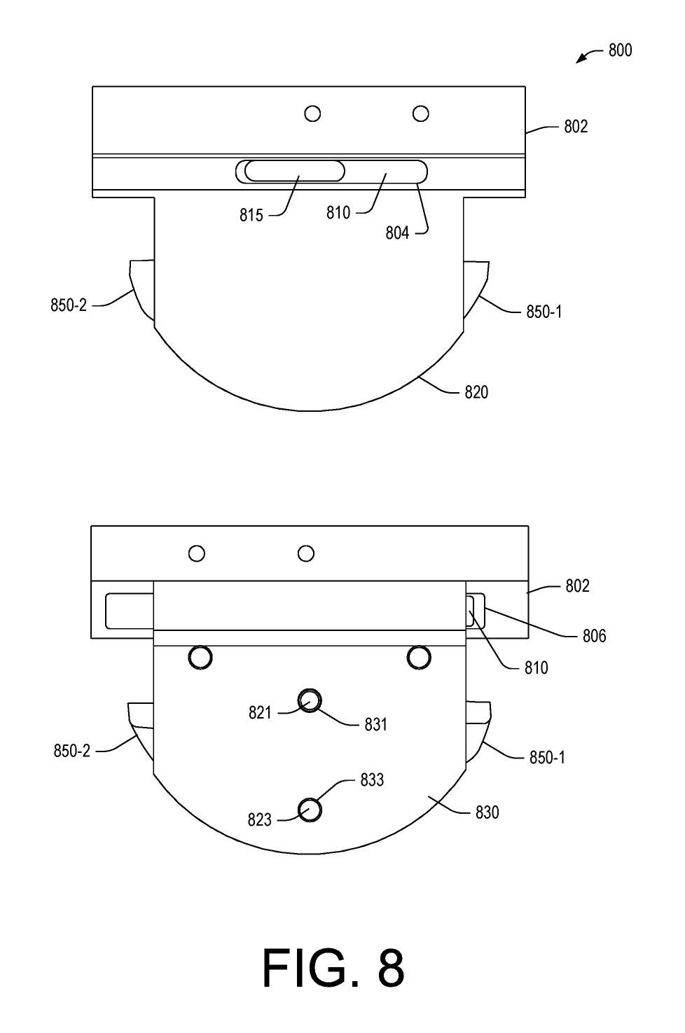

FIG. 8 shows an example of a latch 800 that includes a hinge base 802 for operatively coupling the latch 800 to an axle (e.g., coupled to one or more gears, etc.) and an extension 820 that extends outwardly from the hinge base 802. In the example of FIG. 8, the hinge base 802 includes a first slot 804 as an opening on one side and a second slot 806 as a recess on an opposing side. As shown, a slider 810 includes a raised portion 815 that is received by the first slot 804 while the slider 810 is at least partially received by the second slot 806. As shown, a cap 830 operatively couples to the extension 820 whereby posts 823 of the extension 820 can be received by openings 833 of the cap 830. Further shown in the example of FIG. 8 is an axle 821 that is received by an opening 831 of the cap 830. The axle 821 is part of a mechanism housed by the extension 820 and the cap 830 that is operatively coupled to the slider 810 such that translation of the slider 810 in the slots 804 and 806 causes rotation of a rotational component that is operatively coupled to prongs 850-1 and 850-2 that provide for latching and unlatching a housing or other component.

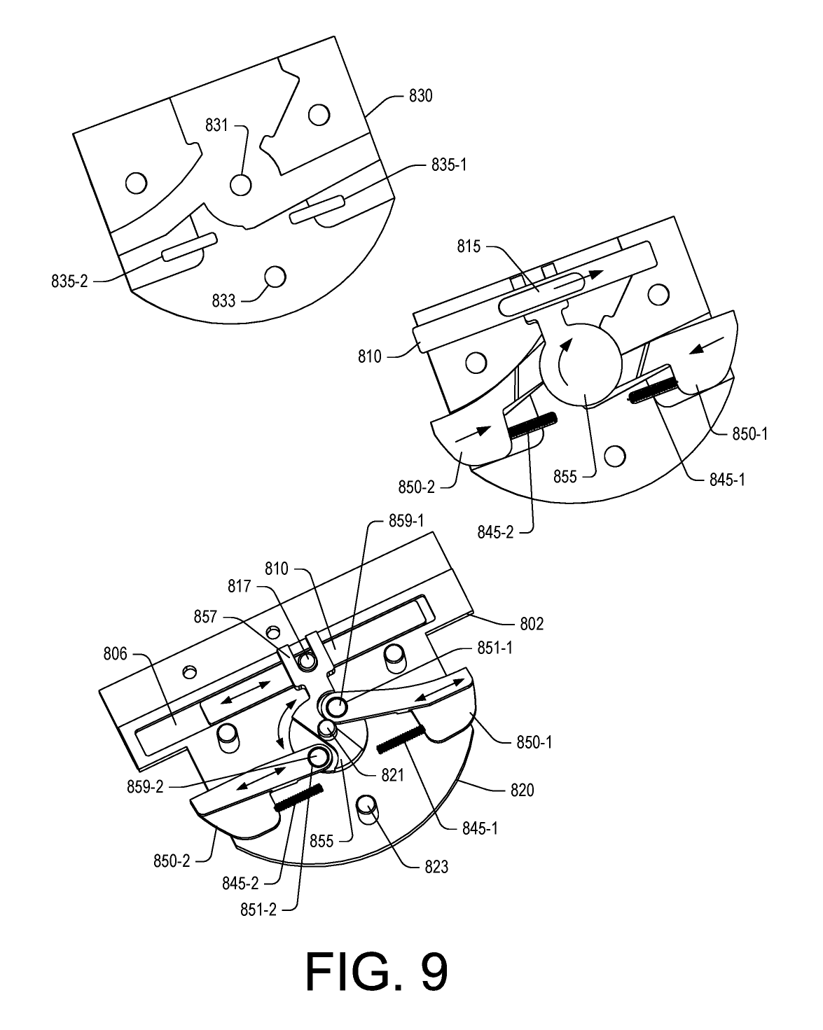

FIG. 9 shows views of the latch 800 including an underside view of the cap 830, an underside view of the cap 830 with the slider 810, a rotational component 855, springs 845-1 and 845-2 that are received at least in part via recesses 835-1 and 835-2 of the cap 830 and the prongs 850-1 and 850-2 where the springs 845-1 and 845-2 bias the prongs 850-1 and 850-2 outwardly in a configuration that corresponds to a latched state. Arrows indicate that translation of the slider 810 to the right causes the rotational component 855 to rotate clockwise, which, in turn, causes the prongs 850-1 and 850-2 to retract inwardly. In such a manner, a housing or other component may be released from the latch 800.

As an example, a housing can include a slot that receives the latch 800 and include recesses that receive the prongs 850-1 and 850-2 such that the latch 800 is operatively coupled to the housing. To release the latch for decoupling of the housing from the latch 800, a user may apply force to the raised portion 815 of the slider 810 to translate the slider 810 where the applied force is sufficient to overcome friction and force of the springs 845-1 and 845-2 such that the prongs 850-1 and 850-2 are drawn inwardly, each a respective distance, to release the latch 800 from a housing.

FIG. 9 shows the extension 820 as including the posts 823 and the slider 810 as including a peg 817 that is received by a fork 857 of the rotational component 855. As the peg 817 is translated in the recess 806, the fork 817 moves in a manner that rotates the rotational component 855 about the axle 821. As shown, the prongs 850-1 and 850-2 are coupled to axles 859-1 and 859-2 of the rotational component 855, for example, the prongs 850-1 and 850-2 can include apertures 851-1 and 851-2 that receive the axles 859-1 and 859-2, respectively.

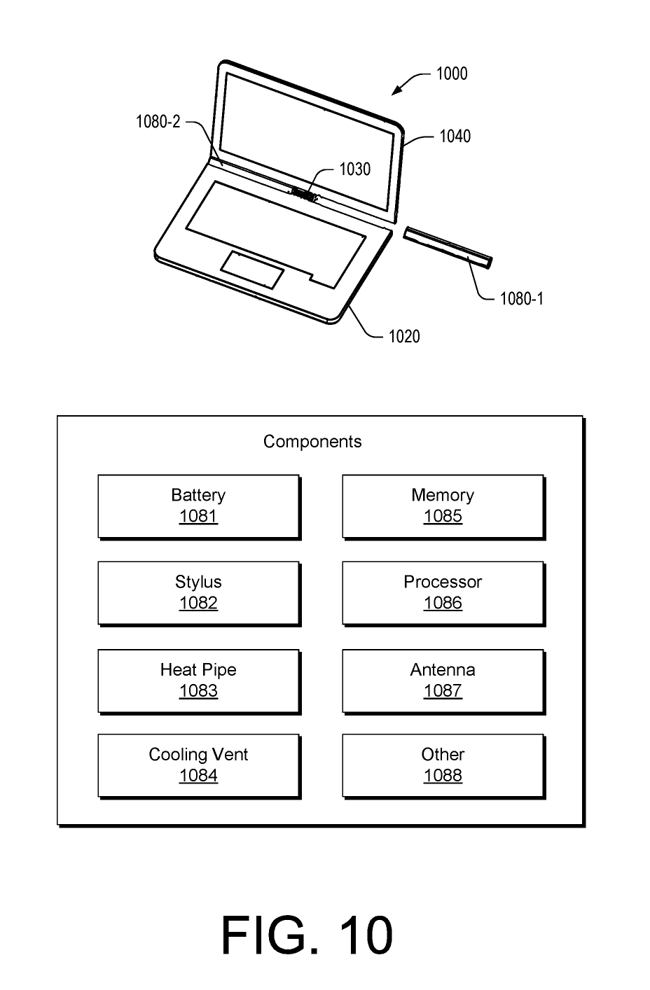

FIG. 10 shows an example of a system 1000 that includes a first housing 1040 and a second housing 1020 operatively coupled via a hinge assembly 1030 where the system 1000 can include one or more components 1080-1 and 1080-2. As an example, the one or more components 1080-1 and 1080-2 can optionally be removable, insertable, replaceable, etc. during operation of circuitry of the system 1000. As an example, the housing 1020 and/or the housing 1040 can include an interface or interfaces that can operatively couple to a component, which may include circuitry. For example, an interface may be a contact interface where electrical contact or contacts are made.

As shown in FIG. 10, the components can include one or more of a battery 1081, a stylus 1082, a heat pipe 1083, a cooling vent 1084, memory 1085, a processor 1086, an antenna 1087 and one or more other components.

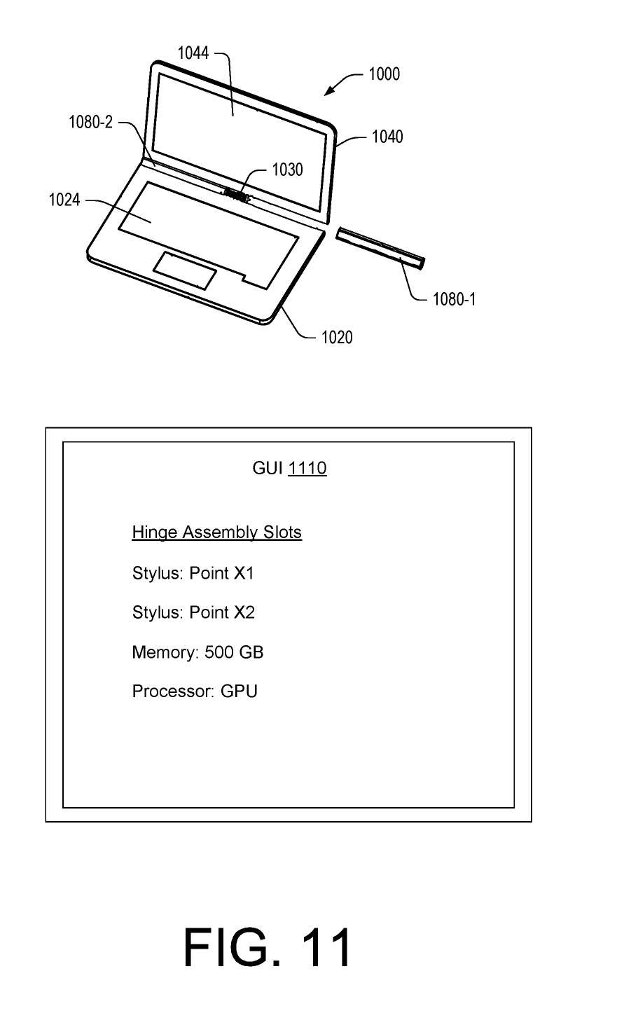

FIG. 11 shows the system 1000 as including a keyboard 1024 and a display 1044 where a graphical user interface 1110 may be rendered to the display 1044, for example, to display information associated with one or more components, which may be hinge assembly slot components. For example, consider an arrangement of components that include a first stylus, a second stylus, memory and a graphics processing unit (GPU). In such an example, the slots may include components for a graphics application that may execute using one or more processors. As an example, the GPU may include a plurality of cores where the memory may be accessible by one or more of the plurality of cores. As an example, the GPU may include circuitry for parallel processing of information and, for example, for rendering graphics to the display 1044. As an example, where a hinge assembly is operatively coupled to a plurality of display housings, such an approach may provide for rendering graphics to a plurality of displays.

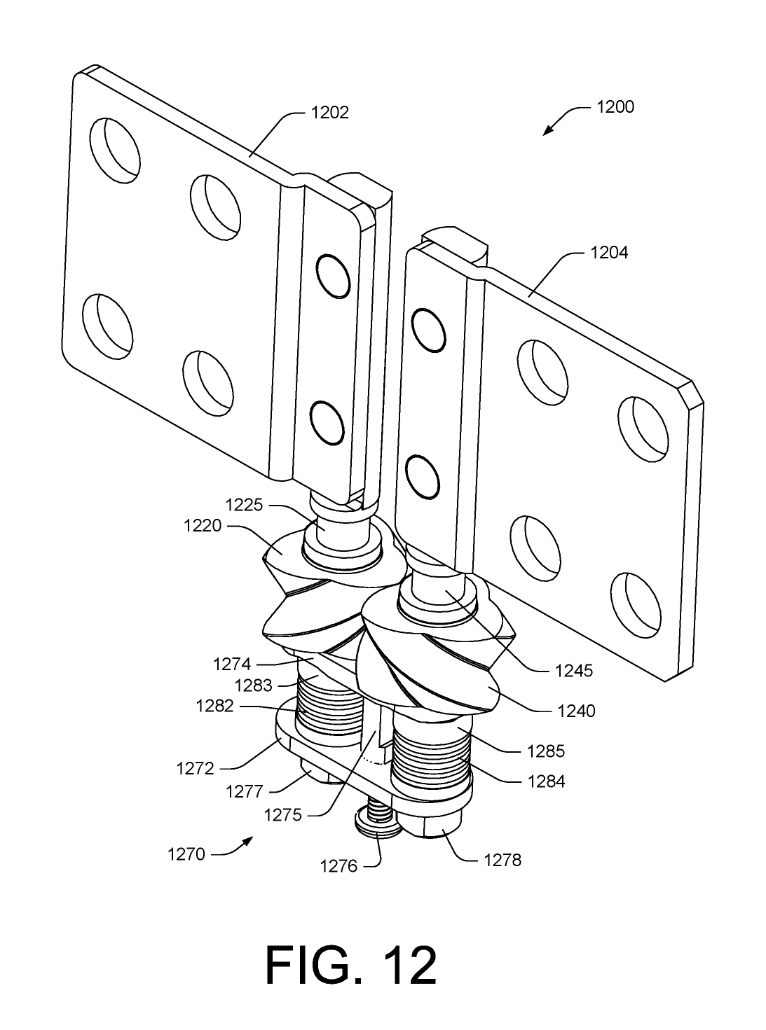

FIG. 12 shows an example of an assembly 1200 that includes housing connectors 1202 and 1204 (e.g., latches) that are operatively coupled to axles 1225 and 1245 of a first gear 1220 and a second gear 1240 where the gears 1220 and 1240 are lobed gears. In such an example, a housing may include one or more latching features that can cooperate with features of one or both of the housing connectors 1202 and 1204. For example, a housing may include a receptacle with one or more prongs, etc. that may couple via openings and/or other features of the housing connectors 1202 and 1204.

As shown in the example of FIG. 12, the assembly can include a coupler 1270 that can include a pair of components 1272 and 1274 that are spaced by a spacer 1275 where the components 1272 and 1274 can receive the axles 1225 and 1245. Between the components 1272 and 1274, the axles 1225 and 1245 may be fit with one or more springs 1282 and 1284. For example, spring washers such as Belleville washers may be fit between the components 1272 and 1274 (e.g., coned-disc springs, conical spring washers, disc springs, cupped spring washer, etc.). A washer may include a frusto-conical shape that imparts a spring characteristic.

As an example, coupler 1270 can include one or more compression mechanisms that can apply force, for example, to one or more springs (e.g., to the spring 1282 and 1284). For example, consider the bolt or screw 1276 and the nuts 1277 and 1278.

As an example, the springs 1282 and 1284 may bias respective cam components 1283 and 1285 that may interact with features of the component 1272 or one or more of the gears 1220 and 1240.

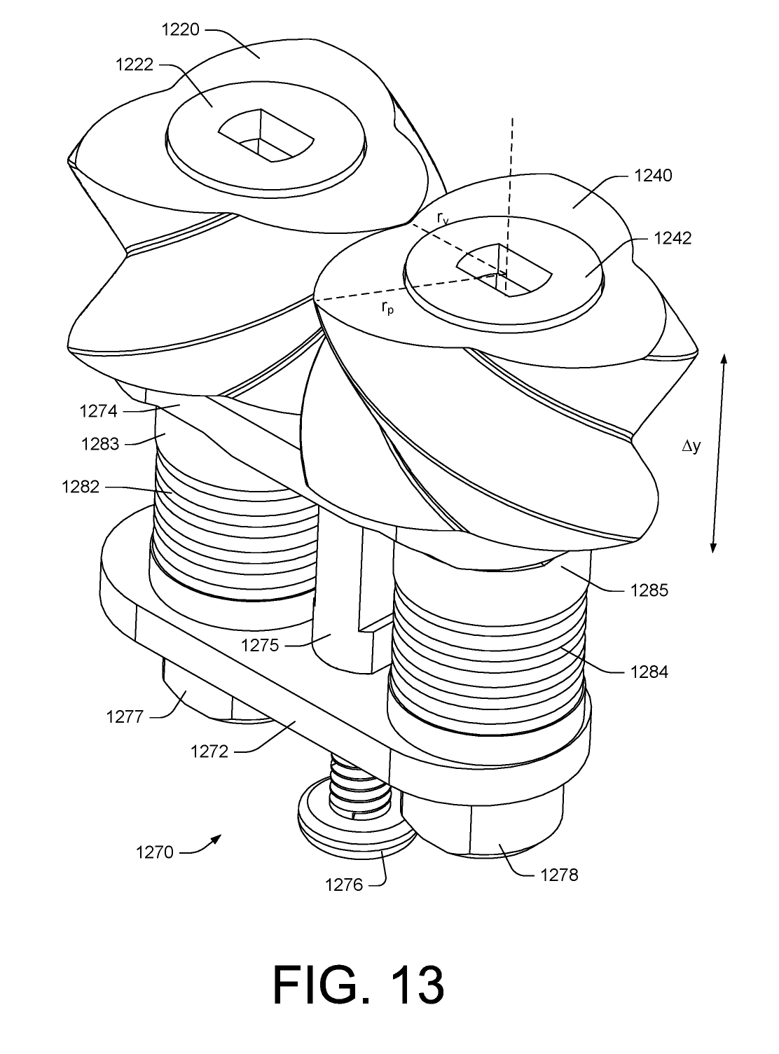

FIG. 13 shows a portion of the assembly 1200 without the housing connectors 1202 and 1204. As shown, the gears 1220 and 1240 may include recesses that can receive components 1222 and 1242, respectively. As shown in the example of FIG. 13, a gear may be defined by a dimension such as, for example, Δy (e.g., a gear length). As shown in the example of FIG. 13, a gear may be defined by dimensions such as a peak radius rₚ and a valley radius rᵥ. In such an example, these radii may be lobe dimensions and define an angle therebetween (e.g., for a half a lobe). As an example, a hinge assembly can include one or more sets of gears such as, for example, the gears 1220 and 1240.

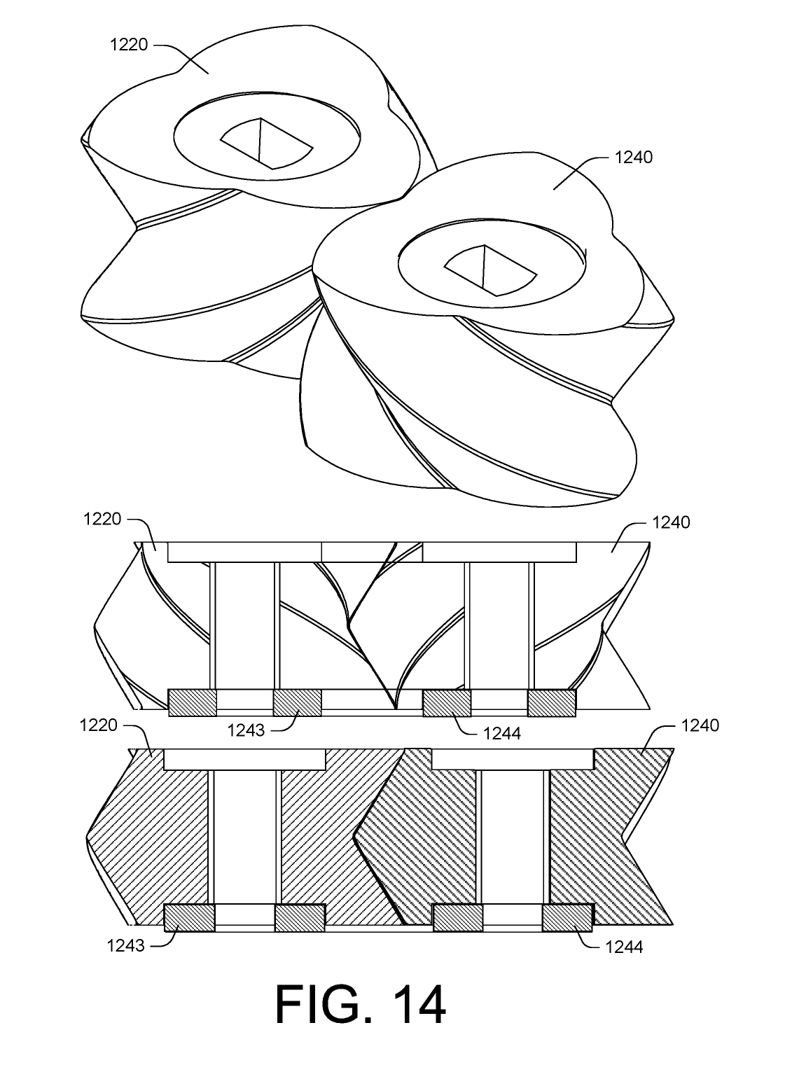

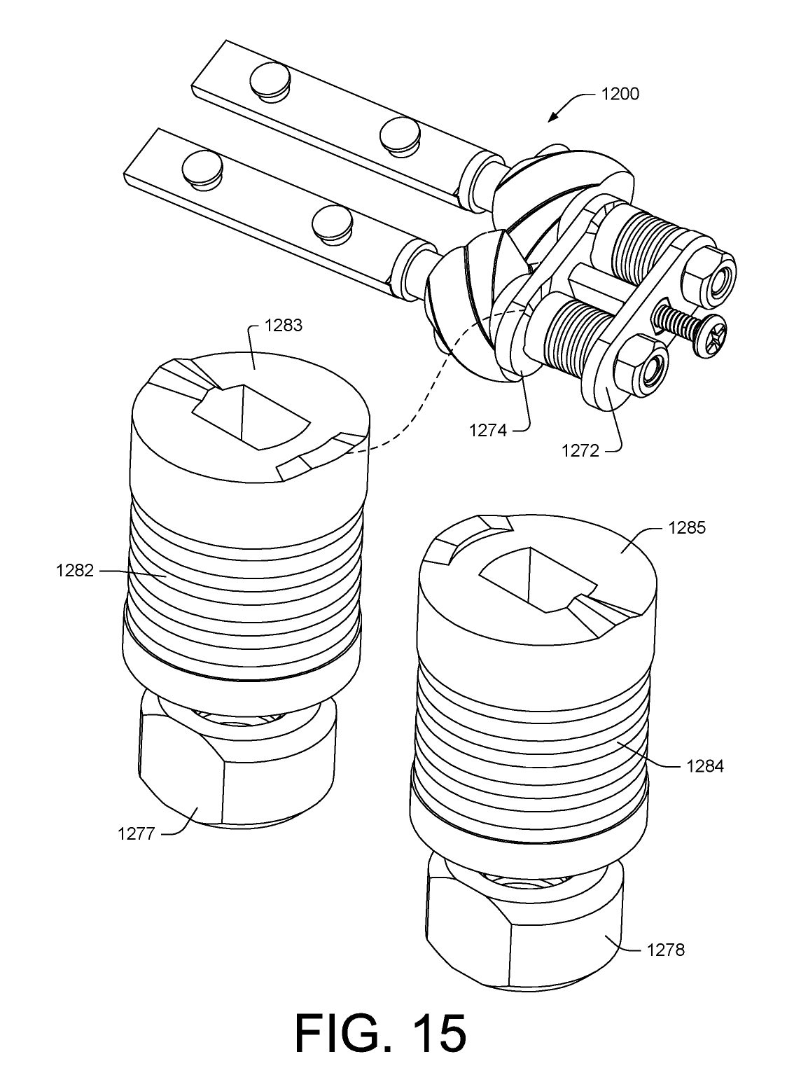

FIG. 14 shows the gears 1220 and 1240 in a perspective view, a hollow cutaway view and in a cross-sectional view along with components 1243 and 1244 received by recesses of the gears 1220 and 1240, respectively. As shown in FIG. 15, each of the gears 1220 and 1240 include three helical lobes. The gears 1220 and 1240 may mesh akin to helical lobed rotor, for example, of a fluid pump.

FIG. 15 shows the assembly 1200 and the cam components 1283 and 1285 as including features that cooperate with features of the component 1274 (see, e.g., dashed line). For example, the features may provide for locking at one or more angles of rotation of a first housing with respect to a second housing. As an example, one component may include a ridge and another component may include a valley that can receive the ridge upon rotation of one of the components with respect to the other one of the components. As an example, a component may include one or more ridges and/or one or more valleys.

In the example assembly 1200, the gears 1220 and 1240 include helical lobes that are different handed. In such an example, the gears 1220 and 1240 rotate in different directions. For example, where the gear 1220 rotates in a clockwise direction, the gear 1240 rotates in a counter-clockwise direction and vice versa. Thus, given a clamshell arrangement of two housing coupled via the assembly 1200, the gears 1220 and 1240 may rotate to orient the housings in a front side to front side orientation and in a back side to back side orientation. As an example, the assembly 1200 may be included as part of a hinge assembly of a system.

As an example, a gear may include an involute profile or a non-involute profile. An involute profile can include teeth that are involutes, for example, of a circle or an ellipse. The involute of a circle may be defined by a spiraling curve traced by the end of an imaginary taut string unwinding itself from that stationary circle called the base circle.

As an example, a hinge assembly can include two elliptical gears, one that may be operatively coupled to a first housing (e.g., a base) and one that may be operatively coupled to a second housing (e.g., top). In such an example, the major axis of the ellipse can be equal in length to the thickness of the first housing while the minor axis of the ellipse can be equal to the second housing thickness, for example, where the first housing may be thicker than the second housing. In such an assembly, a link can connect the gears (e.g., via axles, etc.) where the gears maintain a constant distance (e.g., equal to the sum of the lengths of the major semi-axis and minor semi-axis). In such an example, the hinge assembly can help to ensure smooth rolling and engagement without separation. As an example, gears may be of an elliptical or other shape (e.g., with two dimensions that correspond to two housing thicknesses) and assembled orthogonal to each other (e.g., as defined by the two dimensions). In such an example, coordinated motion may be achieved as one housing is rotated relative to another housing. Such motion may be synchronous motion. As an example, motion may be about 360 degrees, for example, for a back side to back side orientation and a front side to front side orientation of two housings.

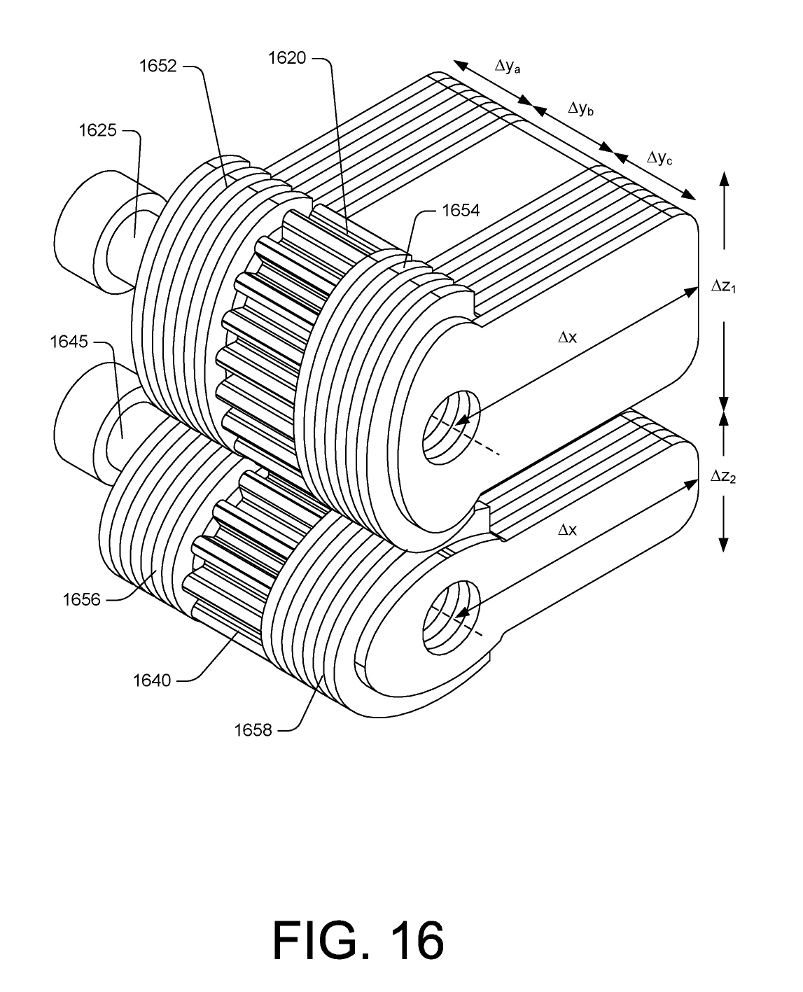

FIG. 16 shows thicknesses Δz₁ and Δz₂ as well as dimensions Δz and Δy, which may be gear region dimensions. FIG. 16 shows a first gear 1620, which may be operatively coupled to a first housing, and a second gear 1640, which may be operatively coupled to a second housing. In such an example, the first and second gears 1620 and 1640 mesh, for example, to orient the first and second housings, for example, in a front side to front side orientation and in a back side to back side orientation. As an example, the gears 1620 and 1640 may be configured to be detached and reattached to one or more housings. As an example, latches may be included in a hinge assembly with gears such as the gears 1620 and 1640.

As an example, the gears 1620 and 1640 can rotate about respective axles 1625 and 1645 that may be coupled via a coupler (e.g., as part of a hinge assembly, etc.). The gears 1620 and 1640 may be elliptical or circular and include teeth. In the example of FIG. 16, sets of plates 1652 and 1654 are disposed adjacent to the gear 1620 and sets of plates 1656 and 1658 are disposed adjacent to the gear 1640. Such plates may mesh, for example, with interference fits therebetween to add friction or with clearances therebetween. Such plates may act as guards that hinder objects from getting caught in the gears 1620 and 1640 as they mesh (e.g., during rotation of at least one of the gears).

As an example, an assembly can include spur gears with spacer and/or side plates. Such an approach may act to reduce risk of finger pinch as the plates, which may be on either side of a spur gear can help prevent a finger from entering a gear contact region. In such an example, an outer perimeter of a plate may match that of a gear teeth outer perimeter, for example, so sliding an assembly, on a delicate desk surface, may be smooth rather than risking a spur gear gouging/marring the surface (e.g., in absence of the plates).

FIG. 16 shows a view of the gears 1620 and 1640, the axles 1625 and 1645 and the sets of plates 1652, 1654, 1656 and 1658. As shown, the sets of plates 1652, 1654, 1656 and 1658 may include extensions or tongue portions and head portions. For example, an extension may be received by a housing to support the head portion of a set of plates. As an example, each of the gears 1620 and 1640 can include a gear head portion and an extension or a tongue where such an extension may be received by a housing to support the gear head portion. Various examples of dimensions are shown in FIG. 16, including an axis to tongue end dimension Δx, thickness dimensions Δz₁ and Δz₂ and dimensions Δyₐ, Δy_{b} and Δy_{c}, which correspond to dimensions of the set of plates 1652, the gear 1620 and the set of plates 1654; noting that dimensions may be specified that correspond to the set of plates 1656, the gear 1640 and the set of plates 1658.

As shown in FIG. 16, shapes may be elliptical and defined by a major axis (a) and a minor axis (b), which intersect at a center. As mentioned, a gear may rotate about an axle where the axle may be at the center of the gear. As an example, one gear may rotate with respect to another gear or gears may rotate in unison (e.g., synchronously). As illustrated in FIG. 16, the gear 1620 may be aligned along a major axis and the gear 1640 may be aligned along a minor axis.

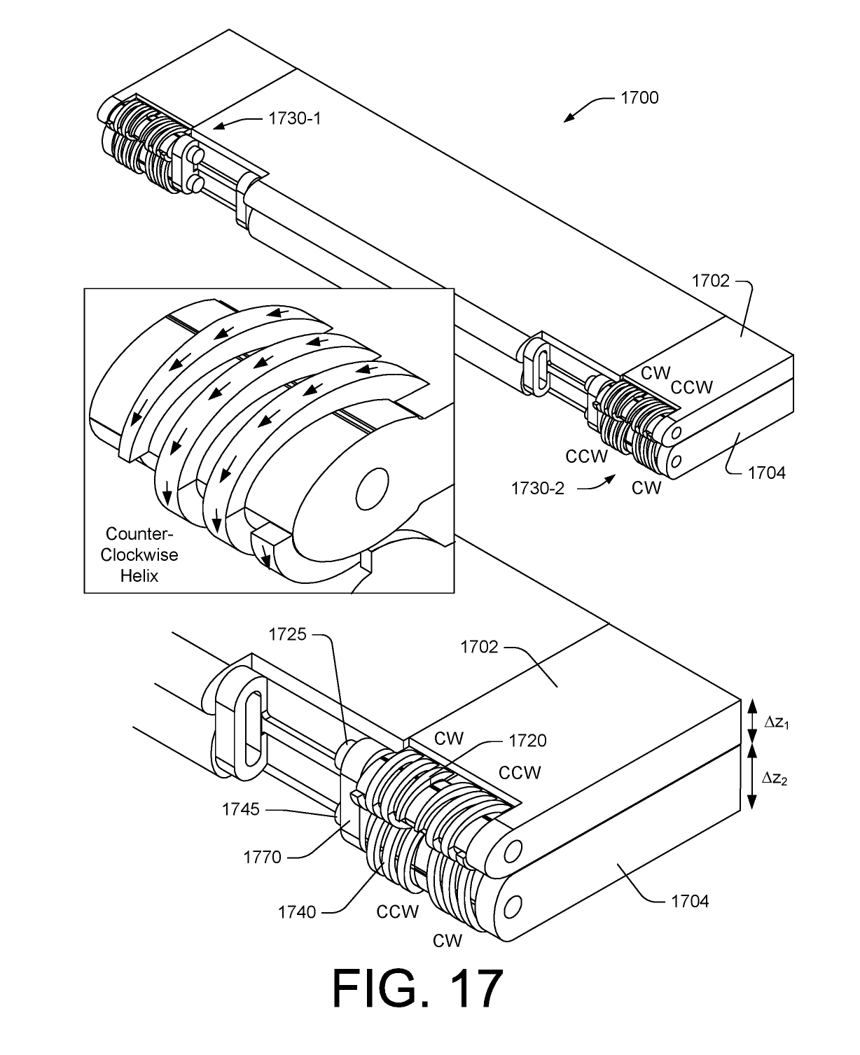

FIG. 17 shows an example of an assembly 1700 that includes a first housing 1702 that includes a front side and a back side and a thickness therebetween, a second housing 1704 that includes a front side and a back side and a thickness, a first set of gears 1730-1 and a second set of gears 1730-2. In the example of FIG. 17, thickness dimensions Δz₁ and Δz₂ are shown for the housings 1702 and 1704, respectively. As an example, the sets of gears 1730-1 and 1730-2 may be included in a hinge assembly or hinge assemblies, which may include one or more latches where, for example, a housing may be decoupled, reoriented and recoupled.

As shown in FIG. 17, a first gear 1720 is operatively coupled to the first housing 1702 and a second gear 1740 is operatively coupled to the second housing 1704. In such an example, the first and second gears 1720 and 1740 mesh to orient the first and second housings 1702 and 1704, for example, in a front side-to-front side orientation and in a back side-to-back side orientation.

In the assembly 1700, the gears 1720 and 1740 rotate about respective axles 1725 and 1745 that are coupled via a coupler 1770 (e.g., as part of a hinge assembly, etc.). For example, the coupler 1770 may be disposed at an end of the gears 1720 and 1740 and receive the axles 1725 and 1745 such that the axles 1725 and 1745 remain a certain distance apart and such that the housings 1702 and 1704 remain coupled during rotation. As an example, a coupler may be proximate to a region through which one or more cables may pass, for example, from one housing to another housing. As an example, an assembly may include more than one coupler. For example, the assembly 1700 may include the coupler 1770 on one side of the gears 1720 and 1740 and another coupler on another side of the gears 1720 and 1740. As an example, a coupler may be positioned between gears, for example, as a spacer between portions of a gear of a first housing and between portions of a gear of a second housing. As an example, the gears 1720 and 1740 may be elliptical, circular or of another shape and include teeth. For example, as shown in FIG. 17, the “teeth” are shaped as helical ridges where adjacent helical ridges are separated by a helical groove (e.g., define a helical groove). In the example of FIG. 17, the gears 1720 and 1740 may be referred to as worm gears.

As shown in an enlarged view, a gear may be defined with respect to a reference frame. For example, using the visible end of the housings 1702 and 1704 as a reference, the gear 1720 includes two portions, one including a counter-clockwise helix (CCW) and the other including a clockwise helix (CW) while the gear 1740 includes two portions, one including a clockwise helix (CW) and the other including a counter-clockwise helix (CCW). Thus, as illustrated in the example of FIG. 17, a CCW portion of the gear 1720 meshes with a CW portion of the gear 1740 and a CW portion of the gear 1720 meshes with a CCW portion of the gear 1740.

As an example, a gear or gears may include multiple portions with helix orientations that may differ (e.g., or be the same). As shown, a corresponding gear or gears may include multiple portions with helix orientations that can mesh with such a gear or gears. As an example, gears may include portions that act to “balance” various forces (e.g., torque, etc.). In such an example, smoother movement may be achieved for movement of a housing with respect to another housing or simultaneous movement of two housings. As an example, a gear with a clockwise portion and a counter-clockwise portion that meshes with another gear with a clockwise portion and a counter-clockwise portion may act to provide for a no-slip condition.

As an example, a hinge assembly can include worm gears. As an example, a worm gear may be perceived, aesthetically, as being different than a spur gear. For example, helical teeth of a worm gear may be perceived as being smoother than the teeth of a spur gear. As an example, a worm gear may be fashion in a more “streamlined” manner. As an example, a worm gear may, when compared to a spur gear, have a less of an industrial look to a user.

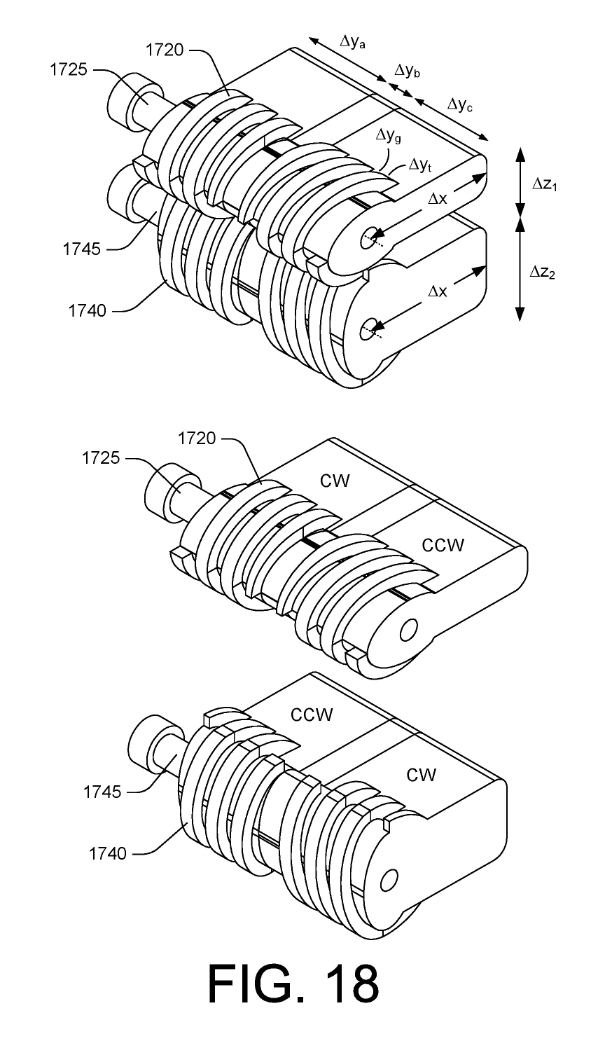

FIG. 18 shows the gears 1720 and 1740 and the axles 1725 and 1745. As illustrated in FIG. 18, the gears 1720 and 1740 can be helical elliptical gears. In such an example, helical grooves defined by helical teeth. Various examples of dimensions are shown in FIG. 18, including an axis to tongue end dimension Δx; thickness dimensions Δz₁ and Δz₂; dimensions Δyₐ, Δy_{b} and Δy_{c}, which correspond to dimensions of a gear or gear portion, a spacer and another gear or gear portion; and dimensions Δy_{g} and Δyₜ, which correspond to a groove dimension and a tooth or ridge dimension. As an example, teeth on a helical gear can be cut at an angle to a gear face. As an example, a helix may include multiple turns (e.g., consider two turns, three turns, etc.). As an example, a gear may be defined at least in part by a pitch (e.g., a pitch of a helix being a dimension of a helix turn as measured in a direction parallel to an axis of the helix). As an example, a gear may be described as being right-handed or left-handed or, for example, clockwise or counter-clockwise. For example, with an observer's line of sight along a helix axis, if a clockwise screwing motion moves the helix away from the observer, then it may be defined as a right-handed helix; if towards the observer, then it may be defined as left-handed helix; or, for example, a stationary helix may be viewed as spiraling away from an observer in a clockwise (CW) or counter-clockwise (CCW) manner. The extent of engagement may make helical gears operate more smoothly (e.g., and quietly) than spur gears.

As shown in FIG. 18, the teeth (e.g., ridges) span an arc angle about a substantially elliptical head portion from which a tongue portion extends. For example, the gear 1720 includes a counter-clockwise portion with approximately four teeth segments (e.g., making about three turns) that define grooves therebetween (e.g., between adjacent segments) and the gear 1720 includes a clockwise portion with approximately four teeth segments (e.g., making about three turns) that define grooves therebetween (e.g., between adjacent segments). The gear 1740 includes a clockwise portion with approximately four teeth segments (e.g., making about three turns) that define grooves therebetween (e.g., between adjacent segments) and the gear 1740 includes a counter-clockwise portion with approximately four teeth segments (e.g., making about three turns) that define grooves therebetween (e.g., between adjacent segments). As illustrated, a segment may differ from another segment. For example, an end segment may include an arc angle less than an intermediate segment.

In the example of FIG. 18, the helixes of the gear 1720 terminate at or near the tongue portion, which is aligned with the major axis of the substantially elliptically shaped head portion while the helixes of the gear 1740 terminate at or near the tongue portion, which is aligned with the minor axis of the substantially elliptically shaped head portion. As an example, with respect to the head portions, in the views of FIG. 18, the gear 1720 may be considered an upward facing while the gear 1740 may be considered forward facing. As an example, where the gear 1740 is stationary, the gear 1720 may rotate about the gear 1740, for example, to achieve an arrangement where the gear 1720 is below the gear 1740 (see, e.g., uppermost view where the gear 1720 is above the gear 1740). In such an example, a “midway” point may be achieved where the tongue portions of the gears 1720 and 1740 extend away from each other, which may be referred to as a planar orientation of the gears 1720 and 1740.

As an example, an assembly may include a portion of the gear 1720 and a portion of the gear 1740. For example, consider a clockwise portion of the gear 1720 and a counter-clockwise portion of the gear 1740 or vice versa. As an example, a gap may exist between portions of a gear. As an example, a gear may include multiple clockwise portions and/or multiple counter-clockwise portions. For example, consider a gear such as the gear 1720 with multiple clockwise portions or with multiple counter-clockwise portions or, for example, the gear 1740 with multiple clockwise portions or with multiple counter-clockwise portions. As to a gap, the example of FIG. 18 shows a gap that is less than an axial length (e.g., along an axle axis) of a portion of a gear (e.g., a clockwise portion or a counter-clockwise portion). As an example, a gap may be of another dimension, which may be defined, for example, with respect to an axial length (e.g., along an axle axis) of a portion of a gear. For example, a gap may be greater than a length of a gear or a portion of a gear.

As mentioned, portions of a gear can include a clockwise portion and a counter-clockwise portion, a clockwise portion and a clockwise portion and/or a counter-clockwise portion and a counter-clockwise portion. As an example, each portion may be of approximately the same axial length (e.g., along an axle axis). As an example, axial lengths of portions may differ. As an example, number of teeth or segments may differ. As an example, number of grooves may differ. As an example, an assembly may include more than one type of gear.

As an example, an assembly can include spacers and worm, face gear “paradoxical” gears with elliptical shapes. In such an example, the assembly may include a first housing and a second housing with different thicknesses. In such an example, worm gears may mesh (e.g., optionally via synchronized motion). As an example, worm gears may include relatively smooth profiles, which may, for example, reduce risk of finger pinch, marring/gouging a surface (e.g., a desk surface), catching clothing (e.g., grabbing a stocking from device placed on a leg or legs), etc. As an example, a left hand elliptic worm with an adjacent right hand elliptical worm in combination (e.g., optionally with a spacer between) may allow for synchronous opening/closing and enforcement of a no-slip condition. As an example, multiple gearing pairs may act to balance (e.g., share) torque load during movement of one housing with respect to another or movement of housings (e.g., synchronously). As an example, a hinge assembly may include gears whereby the gears provide for synchronous movement of latches (e.g., latch portions). In such an example, where housings are operatively coupled to the latches, the housings may be moved synchronously.

As an example, an apparatus can include a processor; memory accessible by the processor; a first housing that includes a front side and a back side; a second housing that includes a front side and a back side; and a hinge assembly operatively coupled to the second housing where the hinge assembly includes a set of axles, a set of gears and a latch pivotable via meshed rotation of the gears about an axis defined by one of the axles where, in a latched state, the latch operatively couples the first housing to the hinge assembly. In such an example, the apparatus can include a hinge assembly housing that covers at least a portion of the set of gears. As an example, such an apparatus can include a battery where, for example, the hinge assembly housing covers at least a portion of the battery where the battery can be shaped such that it includes a longitudinal axis that is substantially parallel to the axis defined by one of the axles.

As an example, a hinge assembly may define an intermediate space between two housings. For example, consider an edge of a first housing that includes a receptacle for receipt of a first latch of a hinge assembly and an edge of a second housing that includes a receptacle for receipt of a second latch of the hinge assembly. In such an example, the edges may be spaced apart by a distance determined at least in part by two axles of the hinge assembly. As an example, an intermediate space or intermediate spaces may provide for inclusion of one or more components. As an example, a component may be a passive component and/or an active component. For example, a passive component may direct flow of air to and/or from an air mover such as a fan; or, for example, a passive component may be a heat sink, optionally with fins or other structural features that can help to dissipate heat energy generated by circuitry operating in a first and/or a second housing that can pivot about a hinge assembly. As an example, an active component may include circuitry that can be operatively coupled to circuitry in a first and/or a second housing that can pivot about a hinge assembly. As an example, an active component may be a battery, memory, a processor, a speaker, a port, an antenna, etc. In such an example, a first and/or a second housing can include one or more interfaces. As an example, a housing can include symmetric interfaces that allow for mounting the housing to a latch of a hinge assembly in one of two orientations.

As an example, a battery can be a component that includes a longitudinal axis that is substantially parallel to an axis defined by one of a plurality of axles of a hinge assembly. In such an example, the battery can include a length along the longitudinal axis that is greater than a cross-sectional dimension of the battery in a plane where the longitudinal axis is substantially normal to the plane.

As an example, an apparatus can include a first housing that includes a display or displays (e.g., multiple displays on a single side and/or displays on opposing sides). As an example, a latched state may be a first latched state where a first housing includes a display that is a front side display that is pivotable about an axle of a hinge assembly to face a front side of a second housing. As an example, a latched state may be a second latched state where first housing includes a display that is a front side display that is pivotable about an axle of a hinge assembly to face a back side of a second housing.

As an example, a hinge assembly can include a first set of gears and a second set of gears and, for example, optionally one or more additional set of gears.

As an example, a hinge assembly can include a first set of axles and a second set of axles and, for example, optionally one or more additional set of axles.

As an example, a hinge assembly can include a set of axles that is a first set of axles and a set of gears that is a first set of gears and, for example, a second set of axles and a second set of gears.

As an example, a latch can include a rotating hub operatively coupled to translating prongs, for example, where a first housing includes a socket (e.g., a receptacle) that receives portions of the translating prongs.

As an example, a hinge assembly can include a first latch that, in a latched state, operatively couples a first housing to the hinge assembly, and a second latch that, in a latched state, operatively couples a second housing to the hinge assembly. In such an example, the hinge assembly can be separable from the first and second housings via the first latch being in an unlatched state and the second latch being in an unlatched state.

As an example, a first housing can include a display and a second housing can include a keyboard.

As an example, a hinge assembly can include gears that include teeth. As an example, a hinge assembly can include gears that include helical gears, for example, where the helical gears can include a clockwise helix gear and a counter-clockwise helix gear. As an example, a hinge assembly can include gears that include lobes.

As an example, an apparatus can include a tablet housing and a base housing where a hinge assembly allows for snap/detach/reattach in one or more angular orientations. As an example, when attached, synchronization may exist between circuitry of the tablet housing and circuitry of the base housing. As an example, a positive snap-action may be utilized to attach and/or detach with positive retention force. As an example, a hinge assembly can include latch portions that include relatively small prongs (e.g., protrusions, ears, etc.), which may not detract substantially from appearance (e.g., aesthetics). As some examples, consider that two housing, a housing and a hinge assembly, more than two housings, a combination of housings and hinge assemblies, etc. may be operatively coupled. In such examples, coupling may be electronically via wire and/or wirelessly. In such example, coupling may be for purposes of air flow.

As an example, at least a portion of hinge assembly may be covered, for example, by a hinge assembly housing, a cover, etc. As an example, a hinge assembly can include one or more components that may be covered by a cover that also covers at least a portion of one or more gears. As an example, a housing may be a stand, include one or more batteries, include one or more storage devices, include a charger, include a heat spreader plate, etc. As an example, a hinge assembly may provide for inclusion of one or more components that can provide one or more functions as to operation of circuitry of a housing or housings.

As an example, an apparatus may be a two-in-one (e.g., ultra portable, convertible) apparatus. As an example, an apparatus can include a hinge assembly that allows for a multi-mode laptop, for example, to provide for a clamshell (e.g., with approximately 360 degree rotation) and, for example, stand, tent and tablet modes. As an example, an apparatus may offer a laptop mode and a detachable tablet (e.g., and/or keyboard) mode. As an example, an apparatus can include a hinge assembly that can utilize a plurality of housings in various modes, which may correspond, at least in part, to orientations of one or more housings with respect to one or more hinge assemblies.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions. Such circuitry may optionally rely on one or more computer-readable media that includes computer-executable instructions. As described herein, a computer-readable medium may be a storage device (e.g., a memory chip, a memory card, a storage disk, etc.) and referred to as a computer-readable storage medium.

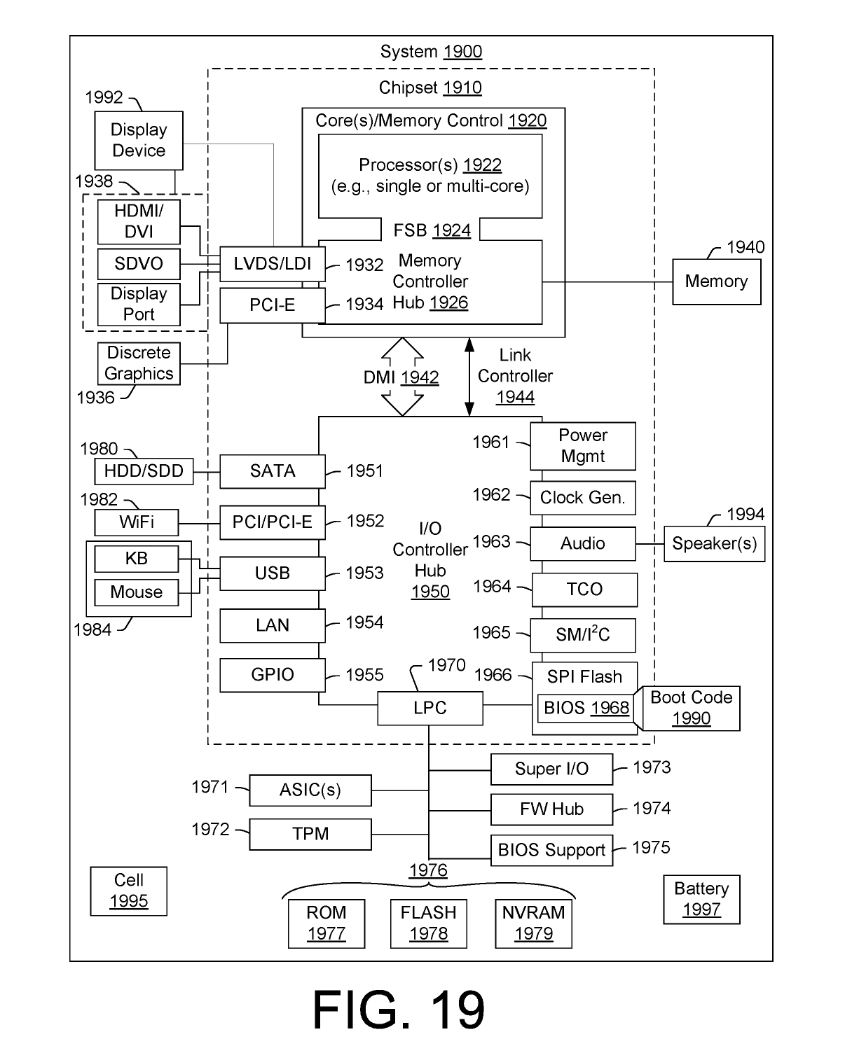

While various examples of circuits or circuitry have been discussed, FIG. 19 depicts a block diagram of an illustrative computer system 1900. The system 1900 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a satellite, a base, a server or other machine may include other features or only some of the features of the system 1900. As an example, a system such as the system 100 of FIG. 1 may include at least some of the features of the system 1900.

As shown in FIG. 19, the system 1900 includes a so-called chipset 1910. A chipset refers to a group of integrated circuits, or chips, that are designed (e.g., configured) to work together. Chipsets are usually marketed as a single product (e.g., consider chipsets marketed under the brands INTEL®, AMD®, etc.).

In the example of FIG. 19, the chipset 1910 has a particular architecture, which may vary to some extent depending on brand or manufacturer. The architecture of the chipset 1910 includes a core and memory control group 1920 and an I/O controller hub 1950 that exchange information (e.g., data, signals, commands, etc.) via, for example, a direct management interface or direct media interface (DMI) 1942 or a link controller 1944. In the example of FIG. 19, the DMI 1942 is a chip-to-chip interface (sometimes referred to as being a link between a “northbridge” and a “southbridge”).

The core and memory control group 1920 include one or more processors 1922 (e.g., single core or multi-core) and a memory controller hub 1926 that exchange information via a front side bus (FSB) 1924. As described herein, various components of the core and memory control group 1920 may be integrated onto a single processor die, for example, to make a chip that supplants the conventional “northbridge” style architecture.

The memory controller hub 1926 interfaces with memory 1940. For example, the memory controller hub 1926 may provide support for DDR SDRAM memory (e.g., DDR, DDR2, DDR3, etc.). In general, the memory 1940 is a type of random-access memory (RAM). It is often referred to as “system memory”.

The memory controller hub 1926 further includes a low-voltage differential signaling interface (LVDS) 1932. The LVDS 1932 may be a so-called LVDS Display Interface (LDI) for support of a display device 1992 (e.g., a CRT, a flat panel, a projector, etc.). A block 1938 includes some examples of technologies that may be supported via the LVDS interface 1932 (e.g., serial digital video, HDMI/DVI, display port). The memory controller hub 1926 also includes one or more PCI-express interfaces (PCI-E) 1934, for example, for support of discrete graphics 1936. Discrete graphics using a PCI-E interface has become an alternative approach to an accelerated graphics port (AGP). For example, the memory controller hub 1926 may include a 16-lane (x16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1950 includes a variety of interfaces. The example of FIG. 19 includes a SATA interface 1951, one or more PCI-E interfaces 1952 (optionally one or more legacy PCI interfaces), one or more USB interfaces 1953, a LAN interface 1954 (more generally a network interface), a general purpose I/O interface (GPIO) 1955, a low-pin count (LPC) interface 1970, a power management interface 1961, a clock generator interface 1962, an audio interface 1963 (e.g., for speakers 1994), a total cost of operation (TCO) interface 1964, a system management bus interface (e.g., a multi-master serial computer bus interface) 1965, and a serial peripheral flash memory/controller interface (SPI Flash) 1966, which, in the example of FIG. 19, includes BIOS 1968 and boot code 1990. With respect to network connections, the I/O hub controller 1950 may include integrated gigabit Ethernet controller lines multiplexed with a PCI-E interface port. Other network features may operate independent of a PCI-E interface.

The interfaces of the I/O hub controller 1950 provide for communication with various devices, networks, etc. For example, the SATA interface 1951 provides for reading, writing or reading and writing information on one or more drives 1980 such as HDDs, SDDs or a combination thereof. The I/O hub controller 1950 may also include an advanced host controller interface (AHCI) to support one or more drives 1980. The PCI-E interface 1952 allows for wireless connections 1982 to devices, networks, etc. The USB interface 1953 provides for input devices 1984 such as keyboards (KB), one or more optical sensors, mice and various other devices (e.g., microphones, cameras, phones, storage, media players, etc.). On or more other types of sensors may optionally rely on the USB interface 1953 or another interface (e.g., I²C, etc.). As to microphones, the system 1900 of FIG. 19 may include hardware (e.g., audio card) appropriately configured for receipt of sound (e.g., user voice, ambient sound, etc.).

In the example of FIG. 19, the LPC interface 1970 provides for use of one or more ASICs 1971, a trusted platform module (TPM) 1972, a super I/O 1973, a firmware hub 1974, BIOS support 1975 as well as various types of memory 1976 such as ROM 1977, Flash 1978, and non-volatile RAM (NVRAM) 1979. With respect to the TPM 1972, this module may be in the form of a chip that can be used to authenticate software and hardware devices. For example, a TPM may be capable of performing platform authentication and may be used to verify that a system seeking access is the expected system.

The system 1900, upon power on, may be configured to execute boot code 1990 for the BIOS 1968, as stored within the SPI Flash 1966, and thereafter processes data under the control of one or more operating systems and application software (e.g., stored in system memory 1940). An operating system may be stored in any of a variety of locations and accessed, for example, according to instructions of the BIOS 1968. Again, as described herein, a satellite, a base, a server or other machine may include fewer or more features than shown in the system 1900 of FIG. 19. Further, the system 1900 of FIG. 19 is shown as optionally include cell phone circuitry 1995, which may include GSM, CDMA, etc., types of circuitry configured for coordinated operation with one or more of the other features of the system 1900. Also shown in FIG. 19 is battery circuitry 1997, which may provide one or more battery, power, etc., associated features (e.g., optionally to instruct one or more other components of the system 1900). As an example, a SMBus may be operable via a LPC (see, e.g., the LPC interface 1970), via an I²C interface (see, e.g., the SM/I²C interface 1965), etc.

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. An apparatus comprising:
a processor;
memory accessible by the processor;
a first housing that comprises a front side and a back side;
a second housing that comprises a front side and a back side; and
a hinge assembly operatively coupled to the second housing wherein the hinge assembly comprises
a set of axles,
a set of gears and
a latch pivotable via meshed rotation of the gears about an axis defined by one of the axles wherein, in a latched state, the latch operatively couples the first housing to the hinge assembly.

2. The apparatus of claim 1 comprising a hinge assembly housing that covers at least a portion of the set of gears.

3. The apparatus of claim 2 further comprising a battery and wherein the hinge assembly housing covers at least a portion of the battery wherein the battery comprises a longitudinal axis that is substantially parallel to the axis defined by one of the axles.

4. The apparatus of claim 1 comprising a battery that comprises a longitudinal axis that is substantially parallel to the axis defined by one of the axles.

5. The apparatus of claim 4 wherein the battery comprises a length along the longitudinal axis that is greater than a cross-sectional dimension of the battery in a plane wherein the longitudinal axis is substantially normal to the plane.

6. The apparatus of claim 1 wherein the first housing comprises a display.

7. The apparatus of claim 6 wherein the latched state comprises a first latched state and wherein the display comprises a front side display that is pivotable about the axle to face the front side of the second housing.

8. The apparatus of claim 6 wherein the latched state comprises a second latched state and wherein the display comprises a front side display that is pivotable about the axle to face the back side of the second housing.

9. The apparatus of claim 1 wherein the set of gears is a first set of gears and comprising a second set of gears

10. The apparatus of claim 1 wherein the set of axles is a first set of axles and comprising a second set of axles.

11. The apparatus of claim 1 wherein the set of axles is a first set of axles and wherein the set of gears is a first set of gears and comprising a second set of axles and a second set of gears.

12. The apparatus of claim 1 wherein the latch comprises a rotating hub operatively coupled to translating prongs.

13. The apparatus of claim 12 wherein the first housing comprises a socket that receives portions of the translating prongs.

14. The apparatus of claim 1 wherein the latch comprises a first latch and comprising a second latch that, in a latched state, operatively couples the second housing to the hinge assembly.

15. The apparatus of claim 14 wherein, the hinge assembly is separable from the first and second housings via the first latch being in an unlatched state and the second latch being in an unlatched state.

16. The apparatus of claim 1 wherein the first housing comprises a display and the second housing comprises a keyboard.

17. The apparatus of claim 1 wherein the gears comprise teeth.

18. The apparatus of claim 1 wherein the gears comprise helical gears.

19. The apparatus of claim 18 wherein the helical gears comprise a clockwise helix gear and a counter-clockwise helix gear.

20. The apparatus of claim 1 wherein the gears comprise lobes.
